(19) United States
(12) Patent Application Publication
(10) Pub. No.: US 2017/0052993 A1
(43) Pub. Date: Feb. 23, 2017

(54) IDENTIFYING TRANSFORMATION MAPS BASED ON INPUT AND OUTPUT FORMATS

(71) Applicant: International Business Machines Corporation, Armonk, NY (US)

(72) Inventors: Michael J. Hudson, Delray Beach, FL (US); Jeffrey A. Wade, Boca Raton, FL (US)

(21) Appl. No.: 14/832,025

(22) Filed: Aug. 21, 2015

(51) Int. Cl. G06F 17/30

(52) U.S. Cl. CPC G06F 17/30345; G06F 17/30011; G06F 17/30058

(57) ABSTRACT

A method for identifying a transformation map includes saving a transformation map to a map repository, associating the saved transformation map with input formats and output formats associated with the transformation map, querying the map repository for a plurality of input document formats and desired output formats to provide a transformation map associated with the plurality of input document formats and desired output formats, and executing a transformation on the plurality of input documents according to the provided transformation map to provide transformed output documents. The method may further include using an API to query the map repository. The method may additionally include using a transform API to transform the plurality of input documents. The method may additionally include registering the API used to query the map repository and the transform API with a service registry. A computer program product and computer system corresponding to the method are also disclosed.

### BACKGROUND OF THE INVENTION

The present invention relates generally to the field of data processing, and more specifically to identifying transformation maps based on input formats and output formats.

Distributed computing architectures rely on the assembly of micro services into a bigger solution. Micro services often exist as specialized computing functions and expose themselves to other services via application programming interfaces (APIs). An API is a set of routines, protocols, and tools for building software applications. APIs express software components in terms of their operations, inputs, outputs, and underlying types. An API additionally defines functionalities that are independent of their respective implementations, which enables definitions and implementations to vary without compromising one another.

### SUMMARY

As disclosed herein, a method for identifying a transformation map includes saving a transformation map to a map repository, associating the saved transformation map with input formats and output formats corresponding to the transformation map, querying the map repository for a plurality of input document formats and desired output formats to provide a transformation map associated with the plurality of input document formats and desired output formats, and executing a transformation on the plurality of input documents according to the provided transformation map to provide transformed output documents. The method may further include using an API to query the map repository. The method may additionally include using a transform API to transform the plurality of input documents. The method may additionally include registering the API used to query the map repository and the transform API with a service registry. A computer program product and computer system corresponding to the method are also disclosed.

### BRIEF DESCRIPTION OF THE DRAWINGS

FIG. 1 is a functional block diagram depicting a computing system in accordance with some embodiments of the present invention;

FIG. 2 is a flowchart depicting a transformation map identification method in accordance with some embodiments of the present invention;

FIG. 3 depicts an example transformation in accordance with one embodiment of the present invention; and

FIG. 4 depicts a block diagram of components of a computer, in accordance with some embodiments of the present invention.

### DETAILED DESCRIPTION

Technologies such as Representational State Transfer (REST) enable APIs to be standardized to some degree, and enable micro services to communicate with other micro services that they are not specifically designed to work with. However, such technologies do not address potentially differing formats of the data exchanged between the services.

In traditional computing solutions, this format mismatch may be addressed by a transformation map. In a distributed computing architecture, this transformation map itself could be exposed as a micro service. Or, more generally, a transformation service which runs maps could also be exposed as a micro service. This service could enable other services to invoke the service, via an API, and provide data in one format to be transformed and returned in another format.

The transformation service transforms data by means of a map. A simplistic transformation may run a fixed, defined map. A more generic service may expose the map to run as a parameter in an API, which would enable another service to pass in the input data and the name of the map to run. The transformation service could then run the specified map and return the transformed data. This method, however, assumes that a calling service has knowledge of which maps are available within the transformation service, and more specifically which map is required to translate a given input to a given output format. Such knowledge breaks the fundamental premise of service based distributed computing since each micro service would need explicit knowledge of the transformation service.

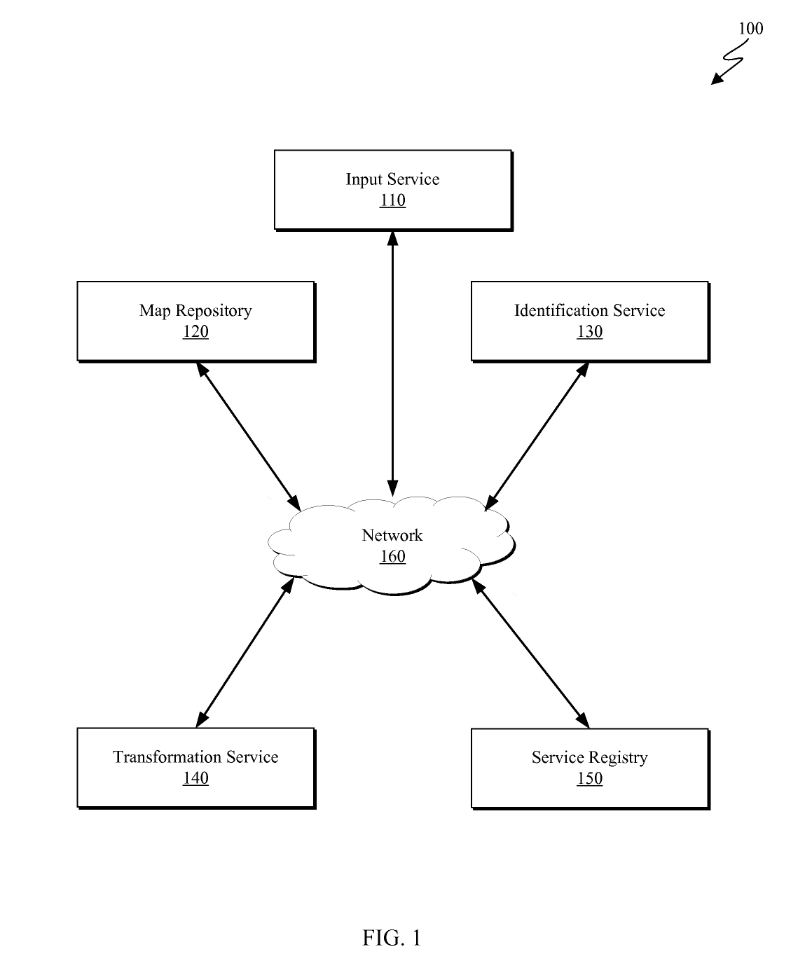

FIG. 1 is a functional block diagram depicting a computing environment 100 in accordance with some embodiments of the present invention. As depicted, computing environment 100 includes input service 110, identification service 130, transformation service 140, map repository 120, service registry 150 and network 160. Computing environment 100 corresponds to an environment in which a transformation map identification method can be executed. In the depicted computing environment 100, input service 110, identification service 130, transformation service 140, map repository 120, and service registry 150 are each hosted on separate computing systems connected via network 160. In other environments, however, any combination of these services may be hosted on the same computing system.

Input service 110 may be an API configured to store a map in map repository 120. Input service 110 may additionally enable the stored map to be associated with the input and output formats associated with the transformation executed by the map. In one embodiment, input service 110 is configured to execute an API call to store a map in map repository 120. In another embodiment, input service 110 has a user interface that enables a client to store maps in map repository 120, and also enables the client to associate the map with relevant input and output formats.

Map repository 120 may be configured to store various maps as provided by input service 110. The map repository may enable maps to be stored, versioned, and retrieved on demand. Map repository 120 may comprise any non-volatile storage media known in the art. For example, map repository 120 can be implemented with a tape library, optical library, one or more independent hard disk drives, or multiple hard disk drives in a redundant array of independent disks (RAID). Similarly, data on map repository 120 may conform to any suitable storage architecture known in the art, such as a file, a relational database, an object-oriented database, and/or one or more tables. Additionally, map repository 120 may be registered as a service with service registry 150, at which point map repository 120 exposes two APIs, such as identification service 130 and transformation service 140.

Identification service 130 may be configured to expose input and output formats as input parameters. Identification service 130 may be configured to query map repository 120 for a map that has been associated with the same input and output formats as those received. Identification service 130 may be configured to then expose the name of the appropriate map as an output parameter. The output parameter may then be provided to transformation service 140.

Transformation service 140 may be configured to receive input documents as well as the transformation map output parameter provided by identification service 130. Transformation service 140 may further be configured to execute the map corresponding to the transformation map received from identification service 130. Exposing the appropriate map on said input documents may provide transformed output documents of a different format.

Service registry 150 may be configured to receive data corresponding to the map repository 120, identification service 130, and transformation service 140. In one embodiment, service registry 150 is configured to receive location information corresponding to map repository 120. In some embodiments, service registry 150 is configured to receive information corresponding to any APIs exposed within computing environment 100.

Network 160 can be, for example, a local area network (LAN), a wide area network (WAN) such as the Internet, or a combination of the two, and include wired, wireless, or fiber optic connections. In general, network 160 can be any combination of connections and protocols that will support communications between input service 110, identification service 130, transformation service 140, map repository 120, and service registry 150 in accordance with an embodiment of the present invention.

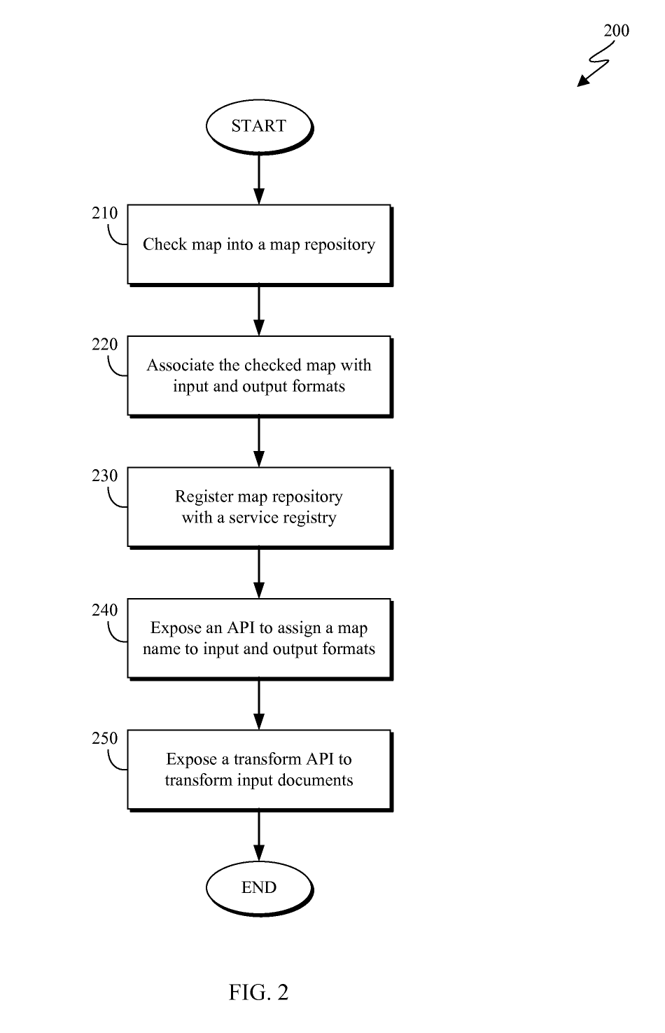

FIG. 2 is a flowchart depicting a transformation map identification method 200 in accordance with some embodiments of the present invention. As depicted, transformation map identification method 200 includes checking (210) a map into a map repository, associating (220) the checked map with input and output formats, registering (230) APIs corresponding to the map repository with a service registry, exposing an API (240) to assign a transformation map to a plurality of input formats and output formats, and exposing a transform API (250) to transform a plurality of input documents. Transformation map identification method 200 may enable input and output formats to be tracked and maps to be queried based on said input and output formats.

Checking (210) a map into a map repository may include using an API call to store a map of interest in a non-volatile storage media such as a map repository. Once checked into the repository, the map may be versioned or retrieved on demand. Checking (210) a map into the map repository may enable said map to be located and identified via a query.

Associating (220) the checked map with input and output formats may include applying tags to the checked map that indicate the input and output formats associated with the checked map. These tags signify what data formats can be transformed using the map, and what data formats the transformation yields. In some embodiments, the maps may be associated with additional information such as a timestamp of a most recent call, or a count of how many times the map has been called.

Registering (230) the map repository with a service registry may include providing location information corresponding to the map repository to a service registry. Registering (230) the map repository may also include providing information regarding APIs exposed by the map repository to a service registry. In some embodiments, the information provided to the service registry corresponds to the APIs exposed to return a transformation map and to transform a plurality of input documents.

Exposing an API (240) to return a transformation map corresponding to a plurality of input formats and output formats may include receiving a plurality of input formats and desired output formats. In some embodiments, a query is then executed on the map repository for a map associated with the received input formats and desired output formats. The query may be executed in the form of an API call. In one embodiment, a query of the form:

String mapname=service.transform(String mapname,Input[ ]inputs) (1)

may be used to return the appropriate transformation map.

Exposing a transform API (250) to transform a plurality of input documents may include receiving a plurality of input documents as well as the transformation map corresponding to the input documents and the desired output format. In some embodiments, a transformation engine loads the appropriate map and executes it by passing the input documents in and returning output documents that are in the desired format. In one embodiment, a query of the form:

Output[ ]output=service.transform(String mapname,Input[ ]inputs) (2)

may be used to return the transformed output documents.

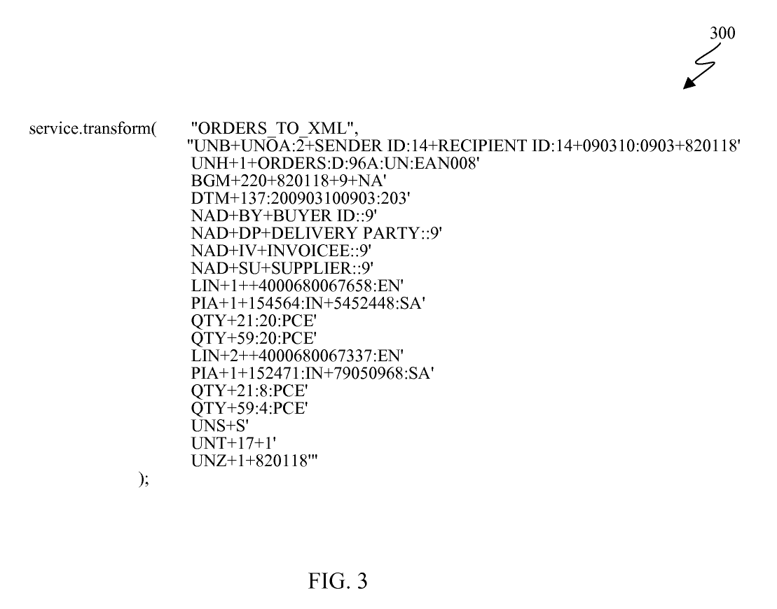

FIG. 3 depicts an example transformation 300 in accordance with one embodiment of the present invention. The depicted transformation 300 is utilized to convert a purchase order into a more computer readable format, such as XML in this case. A query on a map repository for a map capable of converting purchase orders to XML (such as service.lookupMapName(“PurchaseOrder”, “XML”)) would return a map named “ORDERS_TO_XML”. The map is tagged with input format “EDIFACT ORDERS”, and could also be tagged with a more generic label such as “Purchase Order”. The map is also tagged with output format “XML” and also “orders.xsd”, which is the name of the specific XML schema used by the map. Once found, map “ORDERS_TO_XML” can then be invoked via a command such as transformation 300 to provide XML data corresponding to the received purchase orders.

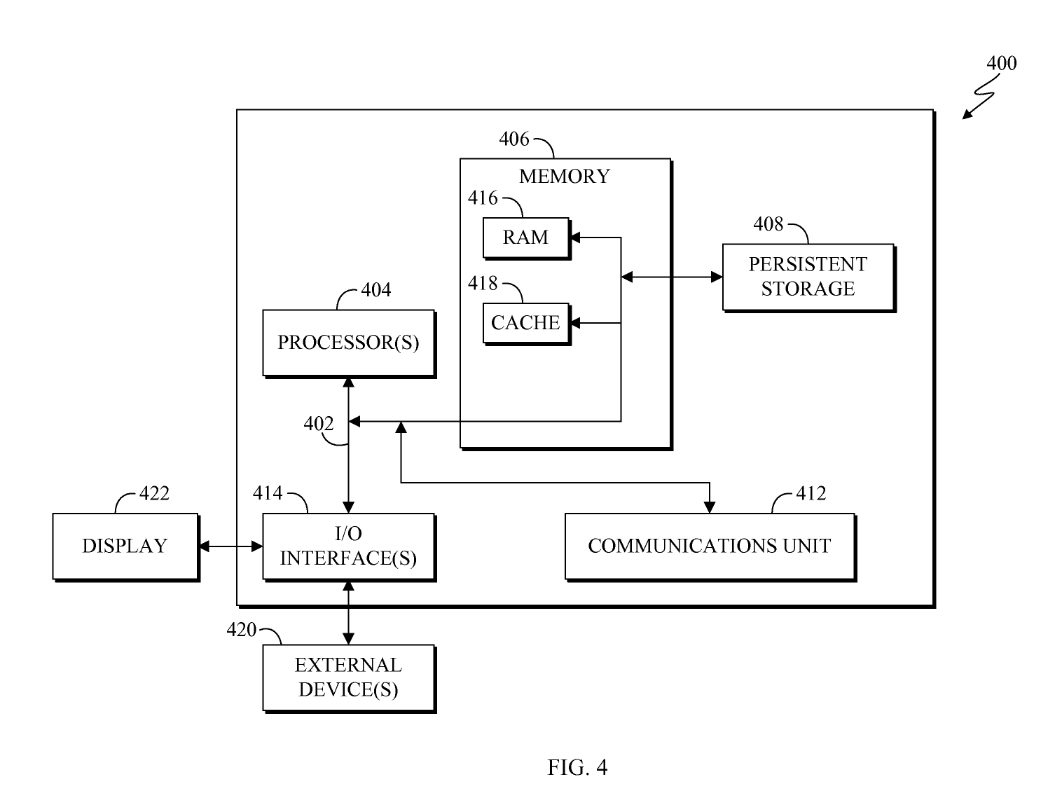

FIG. 4 depicts a block diagram of components of computer 400 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for identifying a transformation map, the method comprising:
saving a transformation map to a map repository;
associating the saved transformation map with input formats and output formats associated with the transformation map;
querying the map repository for a plurality of input document formats and desired output formats to provide a transformation map associated with the plurality of input document formats and desired output formats; and
executing a transformation on the plurality of input documents according to the provided transformation map to provide transformed output documents.

2. The method of claim 1, wherein querying the map repository comprises exposing an API which exposes input document formats and desired output formats as input parameters to provide a transformation map as an output parameter.

3. The method of claim 1, wherein executing a transformation on the plurality of input documents comprises exposing a transform API which takes the provided transformation map and the input documents as input to provide transformed output documents.

4. The method of claim 2, further comprising:
registering the API used to query the map repository with a service registry.

5. The method of claim 3, further comprising:
registering the transform API used to provide transformed output documents with a service registry.

6. The method of claim 1, wherein saving a transformation map to a map repository comprises enabling a user to save a transformation map to a map repository via a user interface.

7. The method of claim 1, wherein associating the saved transformation map with input formats and output formats associated with the transformation map comprises enabling a user to associate the saved transformation map with input formats and output formats associated with the transformation map via a user interface.

8. A computer program product for identifying a transformation map, the computer program product comprising:
one or more computer readable storage media and program instructions stored on the one or more computer readable storage media, the program instructions comprising instructions to:
save a transformation map to a map repository;
associate the saved transformation map with input formats and output formats associated with the transformation map;
query the map repository for a plurality of input document formats and desired output formats to provide a transformation map associated with the plurality of input document formats and desired output formats; and
execute a transformation on the plurality of input documents according to the provided transformation map to provide transformed output documents.

9. The computer program product of claim 8, wherein program instructions to query the map repository comprise program instructions to expose an API which exposes input document formats and desired output formats as input parameters to provide a transformation map as an output parameter.

10. The computer program product of claim 8, wherein program instructions to execute a transformation on the plurality of input documents comprise instructions to expose a transform API which takes the transformation map and the input documents as input and provides transformed output documents.

11. The computer program product of claim 9, further comprising instructions to: register the API used to query the map repository with a service registry.

12. The computer program product of claim 10, further comprising instructions to: register the transform API used to provide transformed output documents with a service registry.

13. The computer program product of claim 8, wherein program instructions to save a transformation map to a map repository comprise instructions to enable a user to save a transformation map to a map repository via a user interface.

14. The computer program product of claim 8, wherein program instructions to associate the saved transformation map with input formats and output formats associated with the transformation map comprise instructions to enable a user to associate the saved transformation map with input and output formats associated with the transformation map via a user interface.

15. A computer system for identifying a transformation map, the computer system comprising:
one or more computer processors;
one or more computer-readable storage media;
program instructions stored on the computer-readable storage media for execution by at least one of the one or more processors, the program instructions comprising instructions to:
save a transformation map to a map repository;
associate the saved transformation map with input formats and output formats associated with the transformation map;
query the map repository for a plurality of input document formats and desired output formats to provide a transformation map associated with the plurality of input document formats and desired output formats; and
execute a transformation on the plurality of input documents according to the provided transformation map to provide transformed output documents.

16. The computer system of claim 15, wherein program instructions to query the map repository comprise program instructions to expose an API which exposes input document formats and desired output formats as input parameters to provide a transformation map as an output parameter.

17. The computer system of claim 15, wherein program instructions to execute a transformation on the plurality of input documents comprise instructions to expose a transform API which takes the transformation map and the input documents as input and provides transformed output documents.

18. The computer system of claim 16, further comprising instructions to:
register the API used to query the map repository with a service registry.

19. The computer system of claim 17, further comprising instructions to:
register the transform API used to provide transformed output documents with a service registry.

20. The computer system of claim 15, wherein program instructions to save a transformation map to a map repository comprise instructions to enable a user to save a transformation map to a map repository via a user interface.
